(19) United States
(12) Patent Application Publication
(10) Pub. No.: US 2009/0010533 A1
(43) Pub. Date: Jan. 8, 2009

(54) METHOD AND APPARATUS FOR DISPLAYING AN ENCODED IMAGE

(75) Inventor: Chih-Wei Hung, Kaohsiung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/871,244

(22) Filed: Oct. 12, 2007

Related U.S. Application Data
(60) Provisional application No. 60/948,002, filed on Jul. 5, 2007.

(51) Int. Cl. G06T 9/00

(52) U.S. Cl. 382/166

(57) ABSTRACT

An apparatus for displaying an encoded image is disclosed. The apparatus comprises a display device and a decoding unit. The decoding unit acquires a Bit-Per-Pixel (BPP) value from an encoded image, acquires a bit stream from the encoded image, acquires multiple pixel data indices by segmenting the bit stream every lengths of the BPP value, acquires a pixel color value of each pixel data index by retrieving a palette comprising multiple unique pixel color values respectively labeled by the pixel data indices, and outputs the acquired pixel color values to the display device for display of the encoded image.

### CROSS REFERENCE TO RELATED APPLICATIONS

This application claims the benefit of U.S. Provisional Application No. 60/948002, filed Jul. 5, 2007, and entitled “METHOD, APPARATUS AND SYSTEM FOR DEVICE-DEPENDENT PALETTE IMAGES”.

### BACKGROUND OF THE INVENTION

1. Field of the Invention

The invention relates to image processing, and more particularly, to methods and apparatuses for encoding and decoding images so as to reduce image display time and image size.

2. Description of the Related Art

The Windows bitmap palette is stored in 24-bit true color due to its device-independent design. To output a bitmap to fewer color depth display devices, such as a bitmap with 16-bit color depth, color format conversion is required. For handheld devices, the color depth of display device is usually less than 24-bit. For example, for a handheld device with an 18-bit LCD display, 6-bits are wasted for displaying 24-bit bitmaps thereon.

Meanwhile, an image comprises pixel data represented by data indices pointing to particular color values of a palette, such as RGB(255,255,255), RGB(0,255,255), or others, in order to reduce storage capacity for storing the bitmap image. During decoding, the color value of each output pixel can then be determined by looking up the palette with a corresponding data index.

While outputting a bitmap to display devices with fewer color depth, however, some color values of the palette may not be utilized but still need to be stored, thus wasting storage space.

### BRIEF SUMMARY OF THE INVENTION

An embodiment of the invention provides a method for displaying encoded images. The method comprises the following steps. A Bits-Per-Pixel (BPP) value is first acquired from an encoded image. A bit stream is then acquired from the encoded image. Multiple pixel data indices are acquired by segmenting the bit stream every lengths corresponding to the BPP value. A pixel color value of each pixel data index is acquired by retrieving a palette comprising multiple unique pixel color values respectively labeled by the pixel data indices. The acquired pixel color values are outputted to a display device for display of the encoded image.

An embodiment of the invention also provides an apparatus for displaying an encoded image. The apparatus comprises a display device and a decoding unit. The decoding unit acquires a Bit-Per-Pixel (BPP) value from an encoded image, acquires a bit stream from the encoded image, acquires multiple pixel data indices by segmenting the bit stream every lengths corresponding to the BPP value, acquires a pixel color value of each pixel data index by retrieving a palette comprising multiple unique pixel color values respectively labeled by the pixel data indices, and outputs the acquired pixel color values to the display device for display of the encoded image.

An embodiment of the invention further provides a method for encoding an input image comprising multiple pixel color values into an encoded image. The method comprises the following steps. The input image is acquired. A palette comprising the unique pixel color values presented in the input image is then generated. A bit-per-pixel (BPP) value capable of representing all unique pixel color values of the palette is calculated, wherein each pixel color value labeled by a data index with a length of the BPP value. Each pixel color value of the input image is converted into one of the color indices of the palette to form a bit stream. Then, the encoded image comprising the BPP value, the palette and the bit stream is generated.

### BRIEF DESCRIPTION OF THE DRAWINGS

The invention can be more fully understood by reading the subsequent detailed description and examples with reference to the accompanying drawings, wherein:

FIG. 1 illustrates a simplified computer system with RAM, ROM, a CPU, a display device, and a display interface.

FIG. 2 illustrates an embodiment of an image system according to the invention.

FIG. 3 illustrates an exemplary process for encoding an input image according to the invention.

FIG. 4 is a flowchart illustrating an exemplary process of decoding an encoded image according to the invention.

FIG. 5 is a schematic diagram illustrating mapping color indices to color values of a palette in FIG. 4.

FIG. 6 is a schematic diagram of an embodiment of an encoder capable of modifying pixel color values consistent with a transparent source key according to the invention.

FIG. 7 is a schematic diagram illustrating an embodiment of the format of encoded bitmap images according to the invention.

FIG. 8 is schematic diagram illustrating an embodiment of a palette comprising color values separately stored in different memory according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

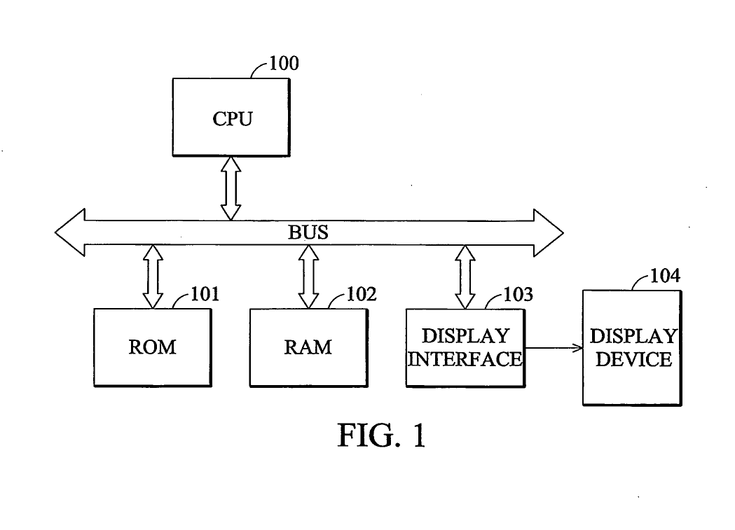

The invention is now described with reference to FIGS. 1 through 8, which generally relate to image encoding and decoding. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the invention. The following detailed description is, therefore, not to be taken in a limiting sense. It should be understood that many of the elements described and illustrated throughout the specification are functional in nature and may be embodied in one or more physical entities or may take other forms beyond those described or depicted.

The embodiments of the invention provide methods and apparatuses for encoding an input image. An image processing system utilizing display device information reduces image decoding time due to encoding efforts. The system is composed of an encoder and a decoder. The encoder converts original pixel color values of an input image into pixel color values conform to a display device, acquires multiple unique values from the converted pixel color values, calculates a Bit-Per-Pixel (BPP) value capable of representing all acquired unique pixel color values, labels each unique pixel color value with a pixel data index of a length of the BPP value, and generates the palette comprising the acquired unique pixel color values with pixel data indices. The encoder replaces each converted pixel color value of the image with a corresponding pixel data index to generate an encoded bit stream. The encoder further may generate an encoded image comprising a header containing the BPP value, the palette, and the encoded bit stream. The decoder decodes the encoded bit stream according to the BPP value and the palette, and outputs the decoded results to a display device.

Note that, preferably, no pixel color values of the palette are redundant, and each pixel color value is employed in at least one bitmap image stored in an embodiment of a handheld device.

In an embodiment, an apparatus for displaying an encoded image is disclosed. The apparatus comprises a display device and a decoding unit. The decoding unit acquires a BPP value from an encoded image, acquires a bit stream from the encoded image, acquires multiple pixel data indices by segmenting the bit stream every lengths corresponding to the BPP value, acquires a pixel color value of each pixel data index by retrieving a palette comprising multiple unique pixel color values respectively labeled by the pixel data indices, and outputs the acquired pixel color values to the display device for display of the encoded image.

FIG. 1 illustrates an exemplary architecture of a computer system including a central processing unit (CPU) 100, a read-only memory (ROM) 101, a random access memory (RAM) 102, a display interface 103, and a display device 104. To display a bitmap image stored in the ROM 101, the CPU 100 may first read image data of the bitmap image pixel by pixel, represented by data indices to color values of a palette, from the ROM 101, and then decode the image data by replacing data indices with corresponding color values with reference to the content of the palette, and put the decoded pixels to a display buffer of the RAM 102. Subsequently, the display interface 103 reads the display buffer and sends pixel data to the display device 104.

In embedded devices, the ROM 101 is usually slow and has limited storage capacity resulting from the reduction of power consumption and cost. Hence, to speed up display of an image, a simplified image decoder and reduction of image size as well as palette size are desired. It is to be understood that, in some embodiments, the embedded devices may be equipped with the similar but different non-volatile memory to store the bitmap image, and also, the display buffer may be resident on the similar but different volatile memory.

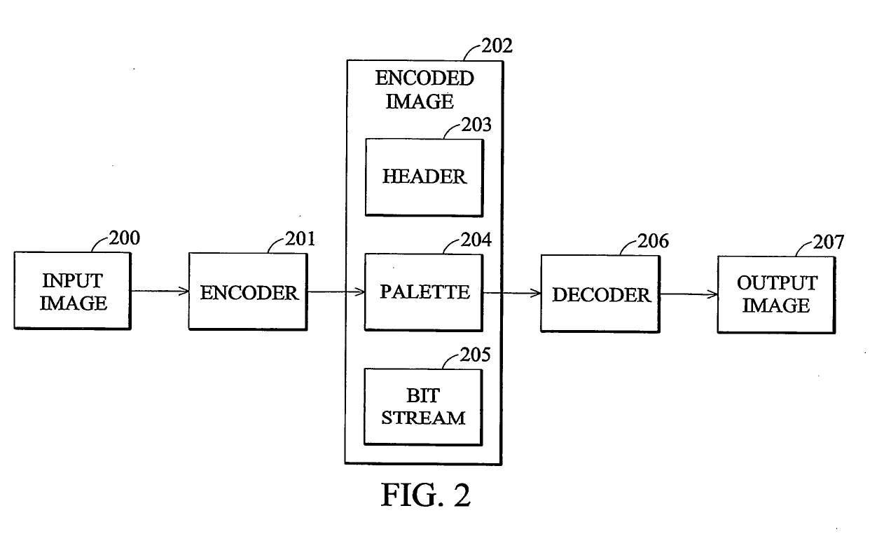

FIG. 2 is a schematic diagram illustrating an embodiment of an image processing system according to the invention. The image processing system comprises an encoder 201 and a decoder 206. The encoder 201 and the decoder 206 are separately resident on two electronic devices. The encoder 201 may operate by hardware circuits disposed on a dedicated electronic device, or by software modules executed by a processor of a computer host. The decoder 206 may operate by hardware circuits of an embedded device, or by software modules executed by a processor of an embedded device.

As shown in FIG. 2, at least one input image 200 is fed into the encoder 201 to generate an encoded image 202 which comprises a header 203, a palette 204 and a bit stream 205. The header 203 contains preliminary information of the encoded image 202, such as a resolution, a BPP value of the bitstream 205, and the similar. The palette 204 contains unique color values employed in the encoded image 202. The bit stream 205 contains color indices of pixels of the images. The length of each color index in the bit stream 205 is indicated by the BPP value of the header 203. The encoded image 202 is transmitted and fed into the decoder 206, and the output image 207 is subsequently obtained.

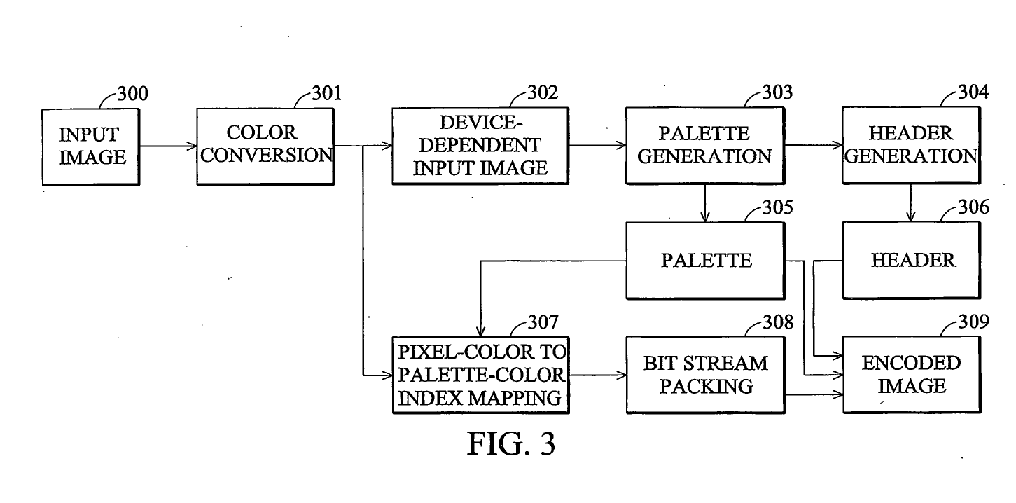

FIG. 3 illustrates an exemplary process by the encoder 210 according to the invention. As shown in FIG. 3, the encoder 210 performs a two-pass operation for an input image 300 to generate an encoded image 309. During a first-pass, an input image 300 is first acquired, and then a color conversion operation 301 is performed thereto to generate a device dependent input image 302. A palette 303 and a header 306 are generated by respectively performing a palette generation operation 303 and a header generation operation 304 to the device dependent input image 302.

In the color conversion operation 301, the input image 300 is converted into a device-dependent bitmap image 302 in the display device color format. For example, an input bitmap image comprising 24-bit true color values may be converted into a device-dependent bitmap image 302 comprising 16-bit display color values.

In the palette generation operation 303, the palette 305 is generated by collecting all unique color values presented in the device-dependent bitmap image 302. Assume that the total number of unique color values in the palette 305 is U, the bits-per-pixel (BPP) for each encoded pixel may be obtained by following formula:

BPP=ceiling(log 2(U)),

where ceiling (x) means the larger one of the two nearest integers of x. This BPP value is used to display an image by the decoder 206.

In the header generation operation 304, the BPP value is encapsulated into the header 306 for decoder usage. In addition, some important information, such as the width and height of the input bitmap image 300, are also stored into the header 306.

After the first-pass operations are completely performed, the device dependent input image 302, the palette 305 and the header 306 are utilized by the second-pass operations.

During a second-pass, a pixel-color to palette-color index mapping operation 307 is performed with the palette 305 and the header 306 generated from the first-pass to obtain a bit stream by a bit stream packing operation 308 so as to generate the encoded image 309.

In the pixel-color to palette-color index mapping operation 307, each pixel value of the device-dependent bitmap image 302 is converted into a color index pointing to a relevant color value of the generated palette 305.

Next, in the bit stream packing operation 308, the data index of each pixel generated by the operation 307 is packed into a bit stream. Then, the header 306, palette 305 and bit stream output by the operation 308 are combined together as the encoded image 309.

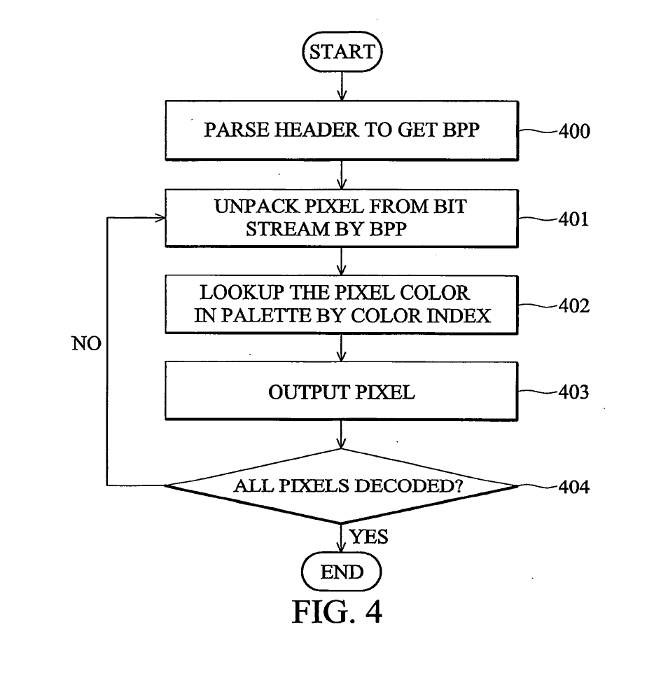

FIG. 4 is a flowchart illustrating an exemplary process of decoding an encoded image, performed by a decoder (e.g. 206), according to the invention.

In step 400, a bits-per-pixel (BPP) value is parsed from the header 306 of the encoded image 309. Next, a pixel decoding loop comprising steps 401 to 404 is illustrated. In step 401, a color index of a pixel is unpacked from a bit stream of the encoded image in use of the BPP value obtained in step 400. In step 402, a particular color value pointed by the unpacked data index is acquired from a palette. In step 403, the acquired color value is output to the display frame buffer. In step 404, it is determined whether all pixels are decoded. If all pixels are completely decoded (Yes in step 404), the pixel decoding loop ends, otherwise, the decoding loop proceeds to step 401 to decode another pixel.

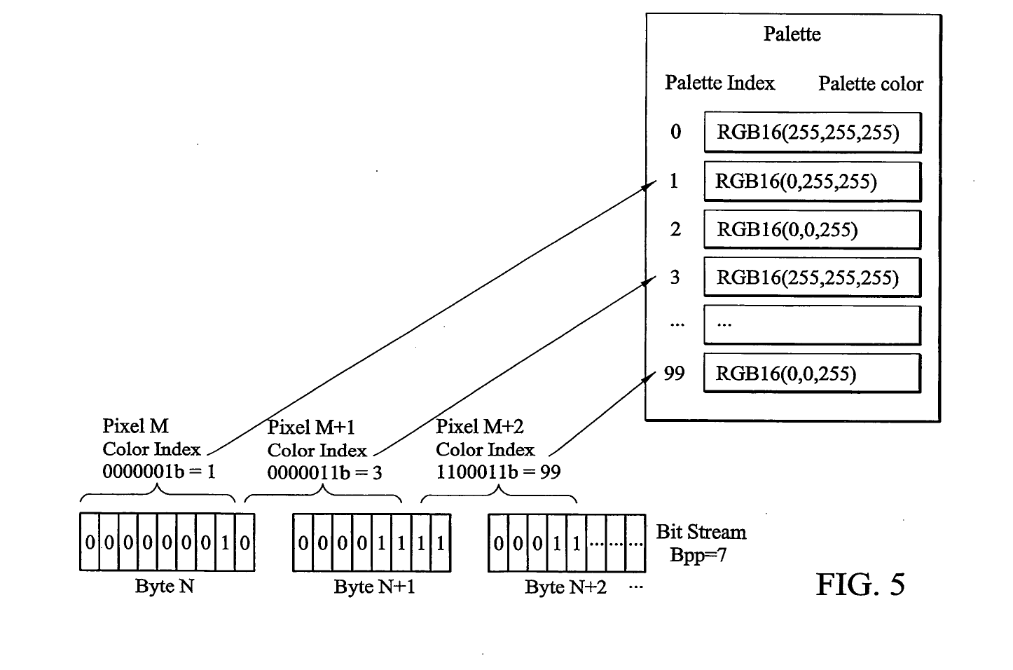

FIG. 5 is a schematic diagram illustrating examples for mapping data indices to color values of a palette, performed in steps 401 and 402, wherein BPP=7. In an embodiment, it is assumed that the total number of the unique color is 100, and thus the BPP is obtained as 7 (=ceiling(log 2(100))). Therefore, each length of pixel data index in bits is 7 (less than a byte), resulting in the reduction of the size of the generated bit stream.

As shown in FIG. 5, each of pixel data indices M, M+1 and M+2 is represented in 7-bits (corresponding to a BPP value), and the bit stream is unpacked (i.e. segmented) every 7-bits. The data indices for pixels M, M+1 and M+2 are 1 (0000001b), 3 (0000011b) and 99 (1100011b), respectively. Then, a relevant pixel color value in the palette 305 is searched by a data index of each pixel. For example, the data index of pixel M is 1, so the pixel color value thereof should be RGB16(0,255,255) from the palette 305. Similarly, the data indices of pixels M+1 and M+2 are 3 and 99, so the pixel color values thereof should be RGB16(255,255,255) and RGB16(0,0,255) respectively. That is, RGB16(0,255,255), RGB16(255,255,255) and RGB16(0,0,255), are respectively outputted when decoding the pixels M, M+1 and M+2

In some embodiments, a decoder comprising graphics hardware is capable of combining several layers into a composite output. A transparent source key of each layer, an essential one, is utilized to combine all layers together. Note that the transparent source key represents “transparent” rather than an actual color value. When a color value of a pixel of one layer equals to the transparent source key of the layer, the color value of the pixel will be ignored. Thereafter, the resulting color value of the pixel will be a color value of the pixel of the lower layer. During encoding, if a pixel color value equals to a transparent source key K in an input image, which is to be output to a layer with the enabled transparent source key K, the pixel color value must be altered to prevent unwanted results.

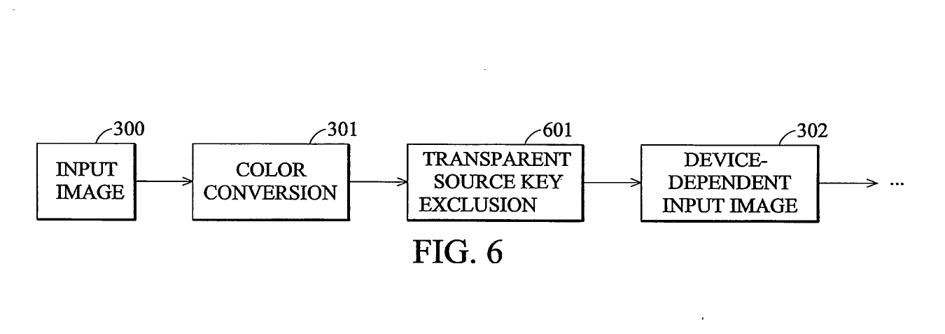

FIG. 6 is a schematic diagram of an embodiment of an encoder capable of modifying pixel color values consistent with a transparent source key according to the invention. Referring together with FIGS. 3 and 6, a new operation 601 is inserted between operations 301 and 302 to modifying pixel color values consistent with a transparent source key before generating the device dependent input image. In the operation 601, it is determined whether a color value C outputted from operation 301 is equal to a transparent source key. If so, the color value C is replaced with a different color value substantially equal to the transparent source key. For example, the color value C may be replaced with a value whose lowest bit (bit 0) of the blue channel of C is toggled by XOR Boolean arithmetic. By performing the aforementioned transparent source key exclusion operations during encoding, the time needed for decoding and displaying the encoded image can be significantly reduced due to elimination of transparent source key comparisons during decoding.

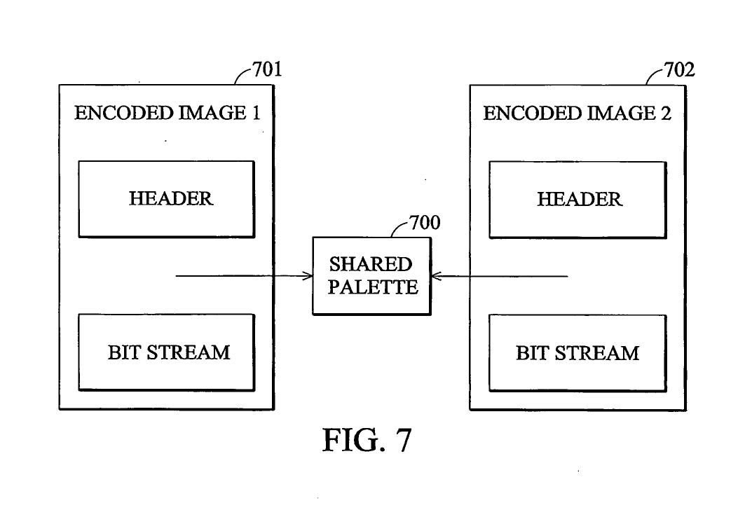

FIG. 7 is a schematic diagram illustrating an embodiment of the format of encoded bitmap images according to the invention. The encoder 201 may create a shared palette 700 for several encoded images, such as 701 and 702 as shown in FIG. 7. The encoded images 701 and 702 may have different headers and bit streams but share the same shared palette 700 via a memory pointer pointing to a region storing the shared palette 700. The decoder 206 may access the shared palette 700 from the memory region indicated by the memory pointer so as to decode the encoded image and display the decoded image. In some embodiments, there may be more than one shared palette and the encoded image may further have multiple memory pointers thereto, as well as, a flag that indicates which shared palette (i.e. memory pointer) is utilized. Therefore, by using shared palettes, the size of the encoded image can be reduced.

The aforementioned palette may be stored in a memory. In some embodiments, the apparatus may comprise more than one memory so that the aforementioned palette may be separated and stored in different memories.

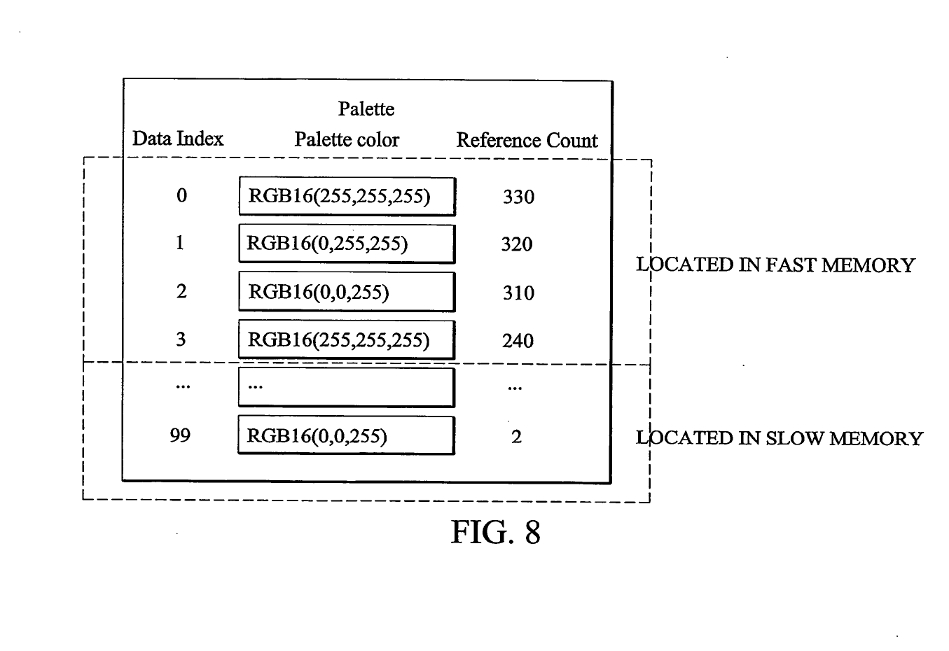

FIG. 8 is a schematic diagram illustrating an embodiment of a palette comprising color values with data indices separated and stored in different memory according to the invention. Assume that at least two memories, e.g. a high-speed memory and a low-speed memory, are disposed on an apparatus. Referring to FIG. 3, in the palette generation operation 303, the encoder 201 generates the palette 305 comprising color values ordered by reference counts thereof in descending. It is to be understood that the high-speed memory is typically more expensive than the low-speed memory, and should be utilized as optimistic as possible. A reference count of a color value represents a total number of the color values presented in one or more encoded images. For example, a reference count of a color value Y is represented as 330 (as palette index 0 in FIG. 8) when counting 330 pixels with the same pixel value Y in the encoded image. The decoder 206 then copies a portion of the palette 305 comprising color values with higher reference counts in the high-speed memory, and the remaining palette comprising color values with lower reference counts in the low-speed memory. Subsequently, the decoder 206 may access the palette 305 by a memory pointer pointing to a start address of a relevant region of the high-speed memory, as well as, a memory pointer pointing to a start address of a relevant region of the low-speed memory. The decoder 206 may access the entire palette by a single memory pointer pointing to a start address of a relevant region of the high-speed memory when the palette is stored in a continuously logical region containing the high-speed and low-speed memories. As shown in FIG. 8, the former four color values of the palette 305 (with data indices 0-3) are stored in the high-speed memory such that the more frequently-used color values can be efficiently acquired to reduce memory access time. The other color values of the palette 305 (with data indices 4-99) are stored in the low-speed memory.

The described embodiments for encoding and decoding images, or certain aspects or portions thereof, may be practiced in logic circuits, or may take the form of program codes (i.e., instructions) embodied in tangible media, such as floppy diskettes, CD-ROMS, hard drives, or any other machine-readable storage medium, wherein, when the program codes are loaded into and executed by a machine, such as a computer, a digital camera, a mobile phone, or similar, the machine becomes an apparatus for practicing the invention. The disclosed methods may also be embodied in the form of program codes transmitted over some transmission medium, such as electrical wiring or cabling, through fiber optics, or via any other form of transmission, wherein, when the program codes are received and loaded into and executed by a machine, the machine becomes an apparatus for practicing the invention. When implemented on a general-purpose processor, the program codes combine with the processor to provide a unique apparatus that operate analogously to specific logic circuits.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. A method for displaying encoded images, performed in an electronic apparatus, comprising:
acquiring a Bits-Per-Pixel (BPP) value from a first encoded image;
acquiring a first bit stream from the first encoded image;
acquiring a plurality of first pixel data indices by segmenting the first bit stream every lengths corresponding to the BPP value;
acquiring a first pixel color value of each first pixel data index by retrieving a palette comprising a plurality of unique pixel color values respectively labeled by the first pixel data indices; and
outputting the acquired first pixel color values to a display device for display of the first encoded image.

2. The method of claim 1, wherein the BPP value is a value other than a multiple of two.

3. The method of claim 1, wherein the electronic apparatus further comprises first and second memories, the access speed of the first memory is faster than that of the second memory, a portion of pixel color values of the palette is stored, in the first memory, and the remaining pixel color values of the palette is stored in the second memory.

4. The method of claim 3, wherein any pixel color value stored in the first memory has more or equal count for the encoded image than that of stored in the second memory.

5. The method of claim 4, wherein the encoded image comprises the palette, the method further comprising:
acquiring the palette from the encoded image; and
storing the acquired palette in a memory of the electronic apparatus.

6. The method of claim 5, wherein the pixel color values correspond to a plurality of reference counts, each reference count indicates a total number of a corresponding pixel color value presented in at least one encoded image.

7. The method of claim 6, wherein the unique pixel color values of the palette are sorted in descending order according to the reference counts thereof.

8. The method of claim 1, wherein the encoded image is a bitmap image.

9. The method of claim 1, further comprising:
acquiring a second bit stream from a second encoded image;
acquiring a plurality of second pixel data indices by segmenting the second bit stream every lengths corresponding to the BPP value;
acquiring a second pixel color value of each second pixel data index by retrieving the palette; and
outputting the acquired second pixel color values to the display device for display of the second encoded image.

10. An apparatus for displaying encoded images, comprising:
a display device; and
a decoding unit acquiring a Bits-Per-Pixel (BPP) value from a first encoded image, acquiring a first bit stream from the first encoded image, acquiring a plurality of first pixel data indices by segmenting the first bit stream every lengths corresponding to the BPP value, acquiring a first pixel color value of each pixel data index by retrieving a palette comprising a plurality of unique pixel color values respectively labeled by the first pixel data indices, and outputting the acquired first pixel color values to the display device for display of the first encoded image.

11. The apparatus of claim 10, further comprising a first memory and a second memory, wherein the access speed of the second memory is faster than that of the first memory, a portion of pixel color values of the palette is stored in the first memory, and the remaining pixel color values of the palette is stored in the second memory.

12. The apparatus of claim 11, wherein the pixel color values correspond to a plurality of reference counts, each reference count indicates a total number of a corresponding pixel color value presented in at least one encoded image.

13. The apparatus of claim 10, wherein the decoder acquires a second bit stream from a second encoded image, acquires a plurality of second pixel data indices by segmenting the second bit stream every lengths of BPP value, acquires a second pixel color value of each second pixel data index by retrieving the palette, and outputs the acquired second pixel color values to the display device for display of the second encoded image.

14. The apparatus of claim 10, further comprising a non-volatile memory, wherein the encoded image is stored in the non-volatile memory.

15. A method for encoding an input image comprising a plurality of pixel color values into an encoded image, comprising:
acquiring the input image;
generating a palette comprising the unique pixel color values presented in the input image;
calculating a bit-per-pixel (BPP) value capable of representing all unique pixel color values of the palette, wherein each pixel color value is labeled by a data index with a length of the BPP value;
converting each pixel color value of the input image into one of the data indices of the palette to form a bit stream; and
generating the encoded image comprising the BPP value, the palette and the bit stream.

16. The method of claim 15, wherein the step of generating the palette further comprises: sorting the unique pixel color values of the palette in descending order according to a plurality of reference counts of the unique pixel color values, wherein each reference count indicates a total number of a corresponding pixel color value presented in the encode image.

17. The method of claim 15, wherein the BPP value is a value other than a multiple of two.

18. The method of claim 15, further comprises:
determining whether each pixel color value being converted equals to a predetermined transparent source key; and
if so, replacing the pixel color value with a different color value substantially equal to the transparent source key.

19. The method of claim 18, wherein the pixel color value is replaced with another color value by toggling the lowest bit of a blue channel of the pixel color value.

20. The method of claim 15, wherein the BPP value is obtained by following formula:
BPP=ceiling (log 2(U)),
where ceiling (X) means the larger one of the two nearest integers of X.
